(19) United States
(12) Patent Application Publication
(10) Pub. No.: US 2017/0102758 A1
(43) Pub. Date: Apr. 13, 2017

(54) WAKE UP GESTURE FOR LOW POWER USING CAPACITIVE TOUCH CONTROLLER

(71) Applicant: STMicroelectronics Asia Pacific Pte Ltd, Singapore (SG)

(72) Inventors: Tchung Jing SIAW, Singapore (SG); Tian Wei WANG, Singapore (SG); Hon Siong NG, Singapore (SG); Ravi BHATIA, Singapore (SG)

(21) Appl. No.: 14/878,954

(22) Filed: Oct. 8, 2015

(51) Int. Cl. G06F 1/32; G06F 3/01; G06F 3/041; G06F 3/044

(52) U.S. Cl. CPC G06F 1/3215; G06F 3/044; G06F 3/017; G06F 3/0416; G06F 1/3231

(57) ABSTRACT

A touch screen controller provides a host interrupt to a host device operating in a low power consumption mode. The touch screen controller uses gesture templates to detect gestures input via a touch screen. Each gesture template is associated with an event identifier, and each event identifier is associated an application. Each gesture template includes a template identifier, a matching threshold, a criterion, and coordinates corresponding to locations on the touch screen panel. If at least one of the coordinates corresponding to a gesture input via the touch screen satisfies the criterion included in a particular gesture template, the touch screen controller provides a host interrupt with the event identifier corresponding to that gesture template to the host device. In response to receiving the host interrupt with the event identifier, the host device exits the low power consumption mode and opens the application associated with the event identifier.

### BACKGROUND

### Technical Field

The present disclosure relates to touch screen devices, and more particularly to touch screen controllers that provide wake-up signals to host devices.

Low power consumption is important to conserve power stored by a power source (e.g. a battery) included in a portable device. Many portable devices include display devices that can consume a considerable amount of power while displaying images. In addition, touch screen devices used in conjunction with such display devices can consume a considerable amount of power while detecting user input. Power consumption generally increases as the size of a display device and the size of a touch screen device increases. Accordingly, there is a need to reduce power consumption in portable devices that include display devices and touch screen devices.

### BRIEF SUMMARY

According to an embodiment, a device is provided. The device includes processing circuitry that is coupled to a processor and that is configured to communicate with a touch screen panel. The device also includes a memory that is coupled to the processor. The memory stores a plurality of gesture templates, wherein each of the gesture templates includes a template identifier, a matching threshold, a criterion, and a first plurality of coordinates, each of the first plurality of coordinates corresponding to a location on the touch screen panel. Additionally, the memory stores processor-executable instructions that, when executed by the processor, cause the device to obtain a second plurality of coordinates, wherein each of the second plurality of coordinates corresponds to a location on the touch screen panel. The instructions also cause the device to obtain a matching distance using the first plurality of coordinates included in a first gesture template of the plurality of gesture templates and the second plurality of coordinates, and compare the matching distance to the matching threshold included in the first gesture template. If the device determines that at least one of the second plurality of coordinates satisfies the criterion included in the first gesture template, the device sends a host interrupt with an event identifier associated with the first gesture template. In response, the host device opens an application associated with the event identifier.

In one embodiment, the second plurality of coordinates is arranged in an order indicating a temporal sequence of detected locations on the touch screen panel. In one embodiment, the criterion included in the first gesture template indicates that a distance between an initial coordinate and a last coordinate of the second plurality of coordinates is less than a specified distance. In one embodiment, the criterion included in the first gesture template indicates that a distance between an initial coordinate and a last coordinate of the second plurality of coordinates is greater than a specified distance. In one embodiment, the criterion included in the first gesture template indicates that a first coordinate of the second plurality of coordinates is within a first specified range of coordinates and that a second coordinate of the second plurality of coordinates is within a second specified range of coordinates. In one embodiment, the processor is configured to receive from an accelerometer a signal that inhibits the processor from detecting a gesture. In one embodiment, the processor is configured to receive from a proximity sensor a signal that inhibits the processor from detecting a gesture.

According to an embodiment, a method is provided. The method includes storing a plurality of gesture templates in a processor-readable memory device, wherein each of the gesture templates includes a template identifier, a matching threshold, a criterion, and a first plurality of coordinates, each of the first plurality of coordinates corresponding to a location on a touch screen panel. A second plurality of coordinates is obtained, wherein each of the second plurality of coordinates corresponds to a location on the touch screen panel. A first gesture template of the plurality of gesture templates is selected based on the matching threshold, criterion, and first plurality of coordinates included in the first gesture template and the second plurality of coordinates. An event identifier associated with the first gesture template is obtained. Additionally, a host interrupt with the event identifier is sent.

In one embodiment, the selecting of the first gesture template includes obtaining a matching distance using the first plurality of coordinates included in the first gesture template and the second plurality of coordinates. The matching distance is compared to the matching threshold included in the first gesture template. If at least one of the second plurality of coordinates is determined to satisfy the criterion included in the first gesture template, the first gesture template is selected.

### BRIEF DESCRIPTION OF THE SEVERAL VIEWS OF THE DRAWINGS

FIG. 1 illustrates a block diagram of a host device, according to an embodiment of the present disclosure.

FIG. 2 illustrates a block diagram of a touch screen device, according to an embodiment of the present disclosure.

FIG. 3 illustrates a block diagram of a host interrupt, according to an embodiment of the present disclosure.

FIG. 4 illustrates a block diagram of a gesture template, according to an embodiment of the present disclosure.

FIG. 5 illustrates a schematic diagram of a portion of the touch screen panel shown in FIG. 2, according to an embodiment of the present disclosure.

FIG. 6 illustrates a flowchart of a process performed by the host device shown in FIG. 1, according to an embodiment of the present disclosure.

FIG. 7 illustrates a flowchart of a process performed by the touch screen device shown in FIG. 2, according to an embodiment of the present disclosure.

FIGS. 8A-8C illustrate a flowchart of a process performed by the touch screen device shown in FIG. 2, according to an embodiment of the present disclosure.

FIGS. 9A-9C illustrate plan views of a user input surface of the touch screen panel shown in FIG. 2 with examples of locations corresponding to coordinates stored by the gesture template shown in FIG. 4, according to an embodiment of the present disclosure.

FIG. 10A shows a plan view of a user input surface of the touch screen panel shown in FIG. 2 with an example of locations corresponding to coordinates generated by the microprocessor shown in FIG. 2 in response to a gesture being input via the touch screen panel, according to an embodiment of the present disclosure.

FIG. 10B shows a plan view of a user input surface of the touch screen panel shown in FIG. 2 with an example of locations corresponding to coordinates generated by the microprocessor shown in FIG. 2 based on the coordinates shown in FIG. 10A, according to an embodiment of the present disclosure.

FIG. 10C shows a plan view of a user input surface of the touch screen panel shown in FIG. 2 with an example of locations corresponding to coordinates generated by the microprocessor shown in FIG. 2 based on the coordinates shown in FIG. 10B, according to an embodiment of the present disclosure.

FIG. 10D shows a plan view of a user input surface of the touch screen panel shown in FIG. 2 with an example of locations corresponding to coordinates generated by the microprocessor shown in FIG. 2 based on the coordinates shown in FIG. 10C, according to an embodiment of the present disclosure.

### DETAILED DESCRIPTION

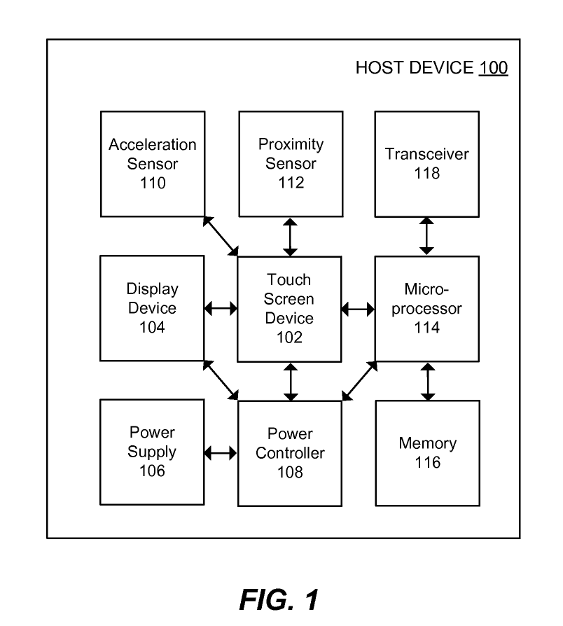

FIG. 1 illustrates a block diagram of a host device 100, according to an embodiment of the present disclosure. For example, the host device 100 may be a cellular telephone, a tablet computer, or a laptop computer having a touch pad.

The host device 100 includes a touch screen device 102, which will be explained in greater detail below. The host device 100 also includes a display device 104, a power supply 106, and a power controller 108. The display device 104 can be of any conventional type, for example, a light emitting diode (LED) type of display device or a liquid crystal display (LCD) type of display device. The power controller 108 controls the power drawn from the power supply 106 by controlling the various devices included in the host device 100. For example, the power controller 108 sends different predetermined signals to the display device 104 to cause the display device 104 to enter a first power saving mode in which the display device 104 does not display images, a second power saving mode in which the display device 104 displays images without backlighting, and a full power consumption mode in which the display device 104 displays images with backlighting.

In one embodiment, the host device 100 includes a conventional accelerometer or acceleration sensor 110 and a conventional proximity sensor 112. In one embodiment, the touch screen device 102 includes the acceleration sensor 110 and the proximity sensor 112. The acceleration sensor 110 outputs a signal when it senses an acceleration that is greater than a predetermined acceleration. The proximity sensor 112 outputs a signal when it senses an object within a predetermined distance from the proximity sensor 112. The signals produced by the acceleration sensor 110 and the proximity sensor 112 are provided to the host device 100 and/or the touch screen device 102.

The host device 100 also includes a microprocessor 114 and a memory 116. The microprocessor 114 may be a conventional microprocessor, for example, a Snapdragon 810 Processor or an Apple A8 Processor. The memory 116 may include Flash memory or any other type of conventional, non-transitory processor-readable memory that allows information to be written thereto and read therefrom. The memory 114 stores instructions that are executed by the microprocessor 114 in a well-known manner. Although not shown, the microprocessor 114 may include a conventional random-access memory (RAM) and a conventional read-only memory (ROM).

The host device 100 also includes conventional transceiver circuitry 118 that sends information to and receives information from other devices. The transceiver circuitry 118 sends and receives signals according conventional communication protocols and standards, for example, one or more of the communication standards included in the IEEE 802.11 family of wireless communication standards, Ethernet communication standards, and Bluetooth® wireless communication standards. The transceiver circuitry 118 also may send and receive signals according to conventional cellular communication standards, for example, those employing Code-Division Multiple Access (CDMA), Time-Division Multiple Access (TDMA), Frequency-Division Multiple Access (FDMA), Orthogonal Frequency Division Multiple Access (OFDMA), Long-Term Evolution (LTE), Global System for Mobile Communications (GSM), and Universal Mobile Telecommunications System (UMTS) technologies.

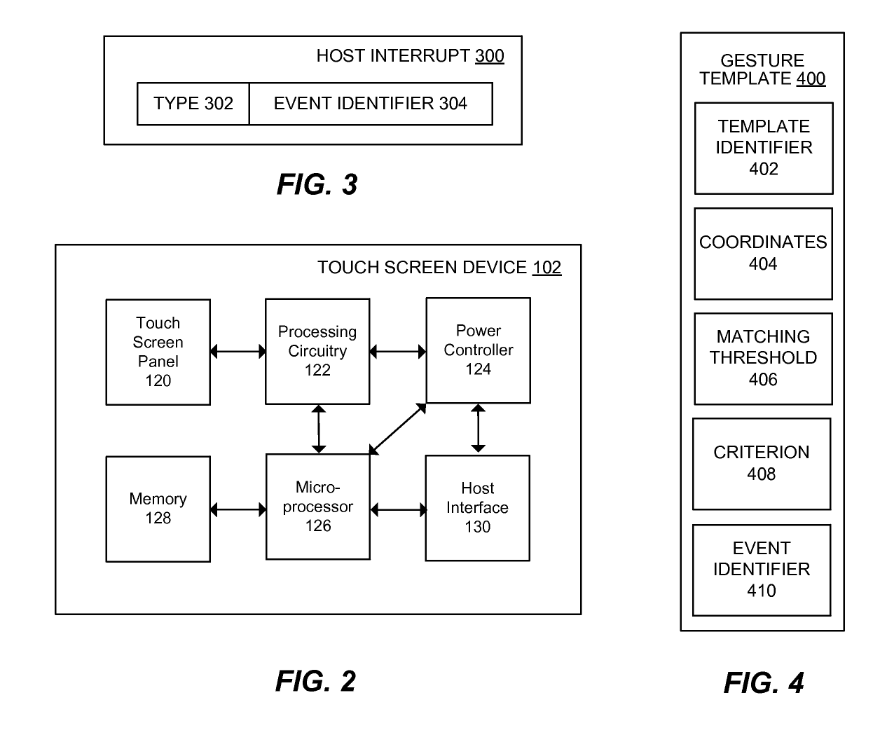

FIG. 2 illustrates a block diagram of the touch screen device 102. In the illustrated embodiment, the touch screen device 102 includes a touch screen panel 120. In another embodiment, the touch screen panel 120 interfaces with the touch screen device 102, however, the touch screen panel 120 is a separate device from the touch screen device 102. For example, the touch screen panel 120 is transparent and is physically coupled to a display surface (not shown) of the display device 104. In such an embodiment, the touch screen device 102 operates as a touch screen controller that generates signals and provides them to the touch screen panel 120 and that processes signals received from the touch screen panel 120. The touch screen panel 120 may be a conventional touch screen panel of a resistive type, a capacitive type, an infrared type, or a surface acoustic wave type, for example. In a preferred embodiment, the touch screen panel 120 is of the capacitive type. The touch screen panel 120 may be included on a track pad of a laptop computer, or on a pointing device such as a mouse, for example. In one embodiment, the touch screen panel 120 is flat. In one embodiment, the touch screen panel 120 is curved and conforms to a curved shape of a user input device such as a mouse, for example.

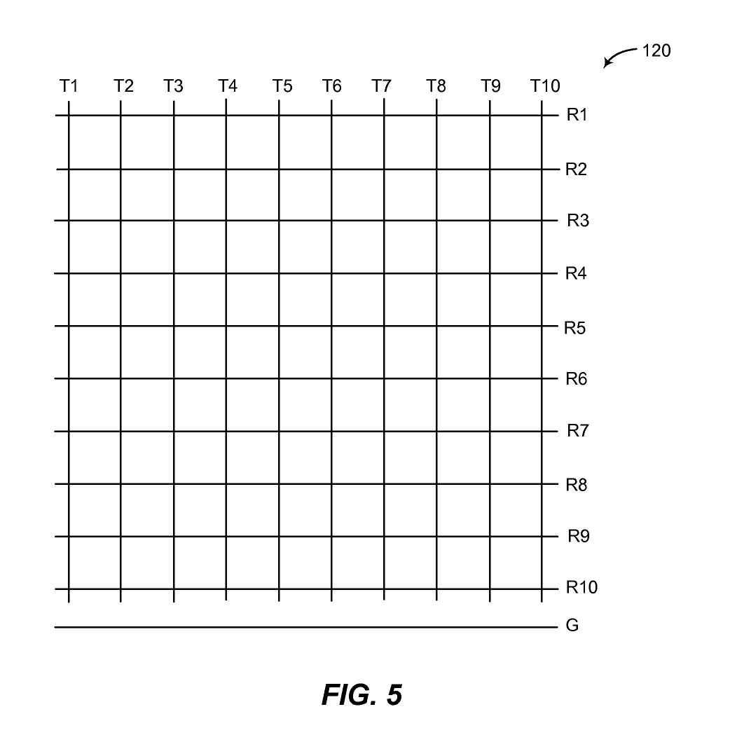

The touch screen device 102 also includes conventional processing circuitry 122 for sending signals to and receiving signals from the touch screen panel 120. The processing circuitry 122 includes a conventional analog front end that generates analog signals having predetermined amplitudes, frequencies, and phases, which are provided to transmitting conductors T1 to T10 (shown in FIG. 5) included in the touch screen panel 120. For example, the processing circuitry 122 includes one or more frequency synthesizers, amplifiers, and signal modulators configured to generate the analog signals provided to the transmitting conductors T1 to T10 of the touch screen panel 120. Additionally, the processing circuitry 122 includes conventional analog-to-digital converters that receive analog signals from receiving conductors R1 to R10 (shown in FIG. 5) included in the touch screen panel 120 and provide corresponding digital signals to a microprocessor 126 of the touch screen device 102.

A power controller 124 controls the power drawn from the power supply 106 of the host device 100 by controlling the various devices included in the touch screen device 102. For example, the power controller 124 sends different predetermined signals to the microprocessor 126 to cause the microprocessor 126 to enter a first power saving mode in which the microprocessor 126 is in a sleep state most of the time and only wakes up (i.e., exits the sleep state) periodically (e.g., 20 Hz) to perform processing operations, a second power saving mode in which the microprocessor 126 is in the sleep state less often and wakes up more frequently (e.g., 90 Hz) to perform processing operations, and a full power consumption mode in which the microprocessor 126 does not enter the sleep state. Accordingly, the power controller 124 causes the microprocessor 126, and thus the touch screen device 102, to operate in at least three different power consumption modes. As described above, such modes may include a first mode in which the microprocessor 126 consumes a first amount of power, a second mode in which the microprocessor 126 consumes a second amount of power that is greater than the first amount of power, and a third mode in which the microprocessor 126 consumes a third amount of power that is greater than the second amount of power.

The microprocessor 126 may be a conventional microprocessor, for example, an ARM1176 processor or an Intel PXA250 processor. The microprocessor 126 is coupled to a memory 128, which can include Flash memory or any other type of conventional, non-transitory processor-readable memory that allows information to be written thereto and read therefrom. The memory 128 stores instructions that are executed by the microprocessor 126 in a well-known manner. Although not shown, the microprocessor 126 may include a conventional RAM and a conventional ROM. The instructions stored by the memory 128 cause the microprocessor 126 to control the processing circuitry 122 such that it sends signals to the transmitting conductors T1 to T10 of the touch screen panel 120 and processes signals received from the receiving conductors R1 to R10 of the touch screen panel 120. The signals are transmitted and received in order to determine if a user is attempting to enter input via touch screen panel 120, and if input is detected, to determine a gesture corresponding to the input. For example, such gestures may include: drag item, flick finger, tap, tap and hold, nudge, pinch, spread, and slide gestures. Additionally, such gestures may include a circle, the letter “o”, a tick or check mark, the letter “S”, the letter “W”, the letter “M”, the letter “C”, and the letter “e”.

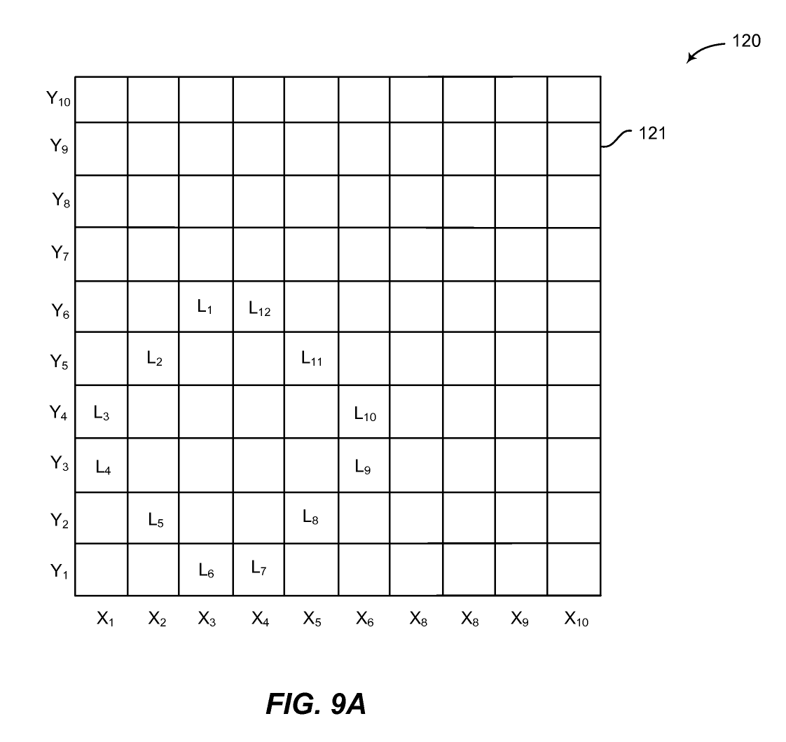

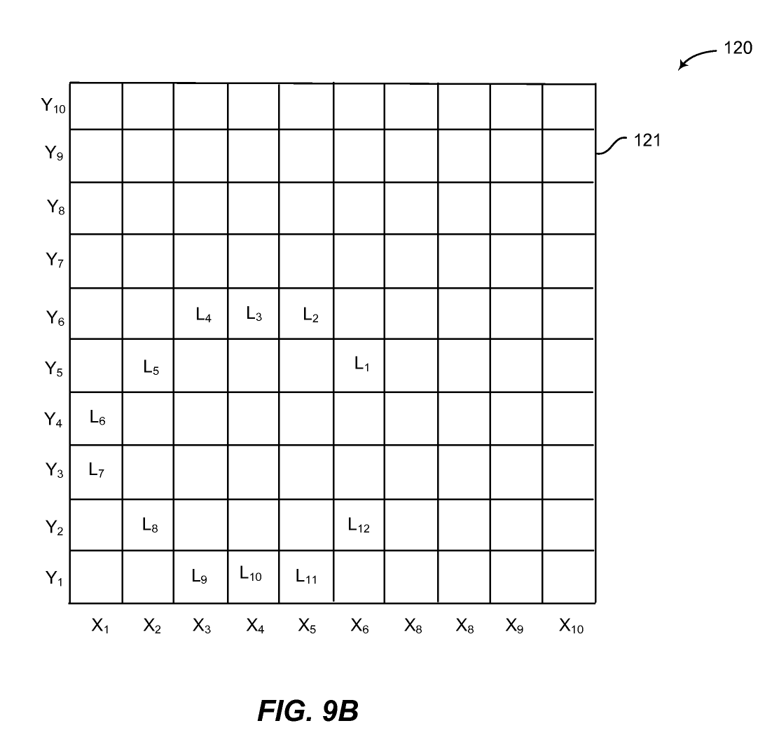

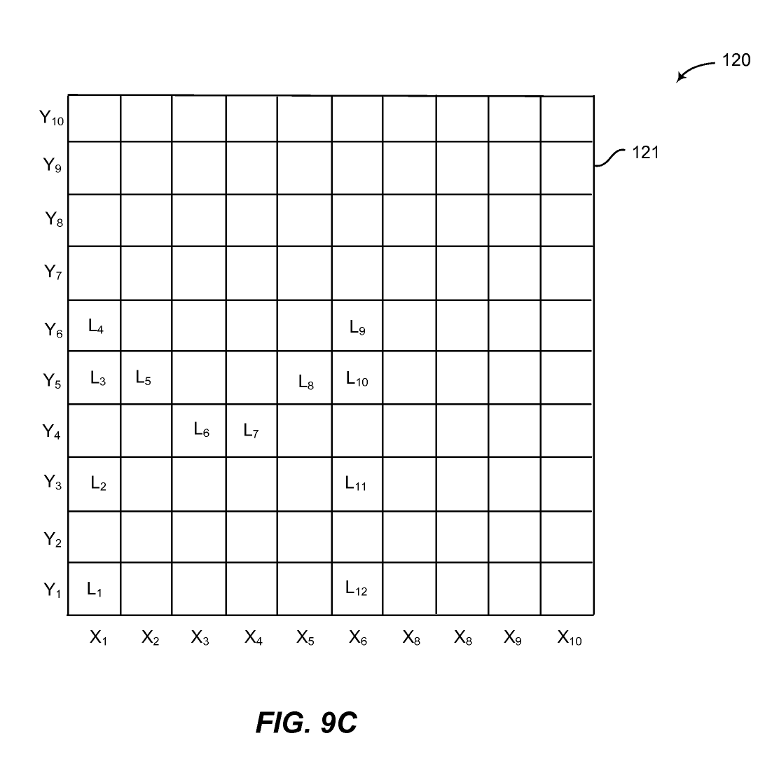

To determine whether a user has made a predetermined gesture via the touch screen panel 120, the instructions stored by the memory 128 cause the microprocessor 126 to keep track of each location on a user input surface 121 (see FIG. 9) of the touch screen panel 120 at which the presence of an object (e.g., a stylus or a finger) has been detected. The user input surface 121 of the touch screen panel 120 is formed from a transparent material, for example, transparent glass. The microprocessor 126 may keep track of each location on the user input surface 121 of the touch screen panel 120 during detection of a uni-stroke gesture, which is a single gesture made using a single stroke of an object. For example, a uni-stroke gesture may be made by a user contacting the user input surface 121 of the touch screen panel 120 with her finger, moving her finger in a pattern corresponding to a letter, and then lifting her finger away from the input surface of the touch screen panel 120. A single-tap gesture is an example of a uni-stroke gesture.

Additionally, the instructions stored by the memory 128 may cause the microprocessor 126 to keep track of each location on the user input surface 121 of the touch screen panel 120 during detection of a multi-stroke gesture, which is at least one gesture made using two or more strokes of one or more objects (e.g., fingers). For example, a multi-stroke gesture may be made by a user tapping the user input surface 121 of the touch screen panel 120 with her finger, moving her finger away from the touch screen panel 120, tapping the user input surface of the touch screen panel 120 again with her finger, and then moving her finger away from the input surface of the touch screen panel 120. A double-tap gesture is an example of a multi-stroke gesture.

The touch screen device 102 also includes a host interface 130. The host interface 130 supports conventional communication standards that enable the touch screen device 102 to communicate with the host device 100. In one embodiment, the host interface 130 supports the Inter-Integrated Circuit (I²C) protocol. In one embodiment, the host interface 130 supports the Serial Peripheral Interface (SPI) protocol. In one embodiment, the host interface 130 supports both the I²C protocol and the SPI protocol.

FIG. 3 illustrates a block diagram of a host interrupt 300, according to an embodiment of the present disclosure. The host interrupt 300 includes a type field 302 and an event identifier field 304. The type field 302 is set by the touch screen device 102 to a predetermined value indicating that the host interrupt 300 is of a type that triggers a wake-up event in the host device 100. The event identifier field 304 is set by the touch screen device 102 to a value corresponding to one of a plurality of predetermined event identifiers. Of course other data structures may be used for the host interrupt 300 without departing from the scope of the present disclosure.

FIG. 4 illustrates a block diagram of a gesture template 400 according to an embodiment of the present disclosure. The gesture template 400 includes a template identifier 402, coordinates 404, a matching threshold 406, a criterion 408, and an event identifier 410. The memory 128 of the touch screen device 102 stores a plurality of gesture templates 400. For example, the memory 128 of the touch screen device 102 may store one or more gesture template 400 for each gesture that the microprocessor 126 is programmed to detect. In one embodiment, each gesture template 400 does not include the event identifier 410; the memory 128 stores a table (or other data structure) that associates each template identifier 402 with a corresponding event identifier 410. For example, each entry in the table includes one gesture template identifier 402 and one event identifier 410 that is associated therewith.

FIG. 5 illustrates a schematic diagram of a portion the touch screen panel 120 shown in FIG. 2, according to an embodiment of the present disclosure. In the illustrated embodiment, the touch screen panel 120 is of the capacitive type and includes a plurality of transmitting conductors T1 to T10 arranged in a first direction, and a plurality of receiving conductors R1 to R10 arranged in a second direction. In one embodiment, the first direction is perpendicular to the second direction. The transmitting conductors T1 to T10 and the receiving conductors R1 to R10 are formed from a transparent conductive material, for example, indium tin oxide. The processing circuitry 122 sequentially supplies a signal to each of the transmitting conductors T1 to T10. The processing circuitry 122 also receives a signal from each of the receiving conductors R1 to R10. Of course, the touch screen panel 120 may include a different number of transmitting and receiving conductors without departing from the scope of the present disclosure.

The instructions stored by the memory 128 cause the microprocessor 126 to control the processing circuitry 122 such that the touch screen panel 120 is operated in multiple sensing modes, including a self-sensing mode and a mutual-sensing mode. When the touch screen panel 120 is operated in the self-sensing mode, the microprocessor 126 processes signals received from the processing circuitry 122, wherein each signal is indicative of the capacitance between one of the receiving conductors R1 to R10 and a ground conductor G. When the touch screen panel 120 is operated in the mutual-sensing mode, the microprocessor 126 processes signals received from the processing circuitry 122, wherein each signal is indicative of the capacitance at a point of intersection between one of the transmitting conductors T1 to T10 and one of the receiving conductors R1 to R10. Accordingly, the transmitting conductors T1 to T10 and the receiving conductors R1 to R10 of the touch screen panel 120 may function as capacitive sensors.

In the embodiment shown in FIG. 5, the touch screen panel 120 includes ten receiving conductors R1 to R10. When the touch screen panel 120 is operated in the self-sensing mode, the microprocessor 126 processes ten signals, wherein each of the signals is indicative of a value of the capacitance between one of the receiving conductors R1 to R10 and the ground conductor G. When the touch screen panel 120 is operated in the mutual-sensing mode, the microprocessor 126 processes one hundred signals, wherein each of the signals is indicative of a value the capacitance between one of the transmitting conductors T1 to T10 and one of the receiving conductors R1 to R10. Because the microprocessor 126 processes 90% fewer signals when operating the touch screen panel 120 in the self-sensing mode than when operating the touch screen panel 120 in the mutual-sensing mode, the microprocessor 126 needs to be in a wake state for a relatively short period of time when operating the touch screen panel 120 in the self-sensing mode as compared to the mutual-sensing mode. Accordingly, the microprocessor 126 may consume approximately 90% less power when operating the touch screen panel 120 in the self-sensing mode than when operating the touch screen panel 120 in the mutual-sensing mode.

Based on the signals received from the processing circuitry 122, the microprocessor 126 determines locations on the user input surface 121 of the touch screen panel 120 at (or above) which a user has performed an input operation with an object (e.g., a stylus or a finger). When the touch screen panel 120 is operated in the self-sensing mode, the microprocessor 126 determines the locations on the user input surface 121 of the touch screen panel 120 corresponding to the user input by determining locations at which the measured capacitance is greater than a predetermined value. When the touch screen panel 120 is operated in the mutual-sensing mode, the microprocessor 126 determines the locations on the user input surface 121 of the touch screen panel 120 corresponding to the user input by determining locations at which the measured capacitance is less than a predetermined value. The instructions stored by the memory 128 cause the microprocessor 126 to produce an array of coordinates of locations on the user input surface 121 of the touch screen panel 120 corresponding to a user gesture made on (or over) the touch screen panel 120 in a well-known manner.

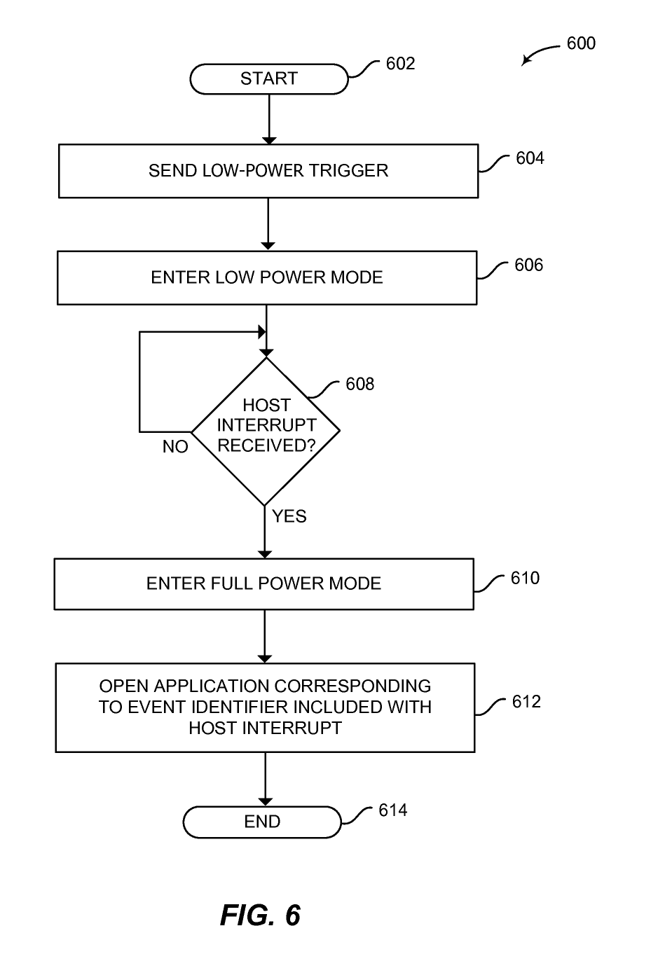

FIG. 6 illustrates a flowchart of a process 600 performed by the host device 100 shown in FIG. 1, according to an embodiment of the present disclosure. The process begins at 602. For example, at 602, the microprocessor 114 determines that a user has not operated the host device 100 for a predetermined amount of time, such as one minute. The process 600 then proceeds to 604.

At 604, the host device 100 sends a low-power trigger signal to the touch screen device 102. For example, the microprocessor 114 causes a predetermined value or a predetermined signal to be provided on one or more conductors that are coupled to the host interface 130 of the touch screen device 102. The process 600 then proceeds to 606.

At 606, the host device 100 enters a low power mode. For example, the microprocessor 114 causes a plurality of devices, including the touch screen device 102 and the display device 104, to enter a mode in which a reduced amount of power is consumed. When one or more devices included in the host device 100 consume a reduced amount of power, the host device 100 is in the lower power mode. The process 600 then proceeds to 608.

At 608, the host device 100 determines whether a host interrupt has been received from the touch screen device 102. For example, at 608, the microprocessor 114 determines whether a signal line has a predetermined voltage level or whether a buffer (or other area of memory) has a predetermined value stored therein. If the host device 100 does not determine that a host interrupt has been received, the process 600 remains at 608 and the host device 100 continues to check for a host interrupt. If the host device 100 determines that a host interrupt has been received at 608, the process 600 proceeds to 610.

At 610, the host device 100 enters a full power mode. For example, the microprocessor 114 causes a wake-up signal to be sent to each of the devices that were previously in the low power mode, including the touch screen device 102 and the display device 104. When each device included in the host device 100 is capable of consuming a full amount of power, the host device 100 is in the full power mode. The process 600 then proceeds to 612.

At 612, the host device 100 opens or otherwise displays an application corresponding to an event identifier included with the host interrupt received at 608. For example, at 608, the host device 100 receives the host interrupt 300 with the event identifier field 304 set to a value “00000010”. The memory 116 of the host device 100 stores a table (or other data structure) that associates each valid value of the event identifier field 304 with an application (or an executable file that opens the application). The microprocessor 114 uses the value included in the event identifier field 304 to determine a corresponding application to open, and then opens the application in a well-known manner. For example, the table includes an entry that associates the value “00000010” with “mail.dex”, which is a file that is executed to open an electronic mail application. The process 600 then ends at 614.

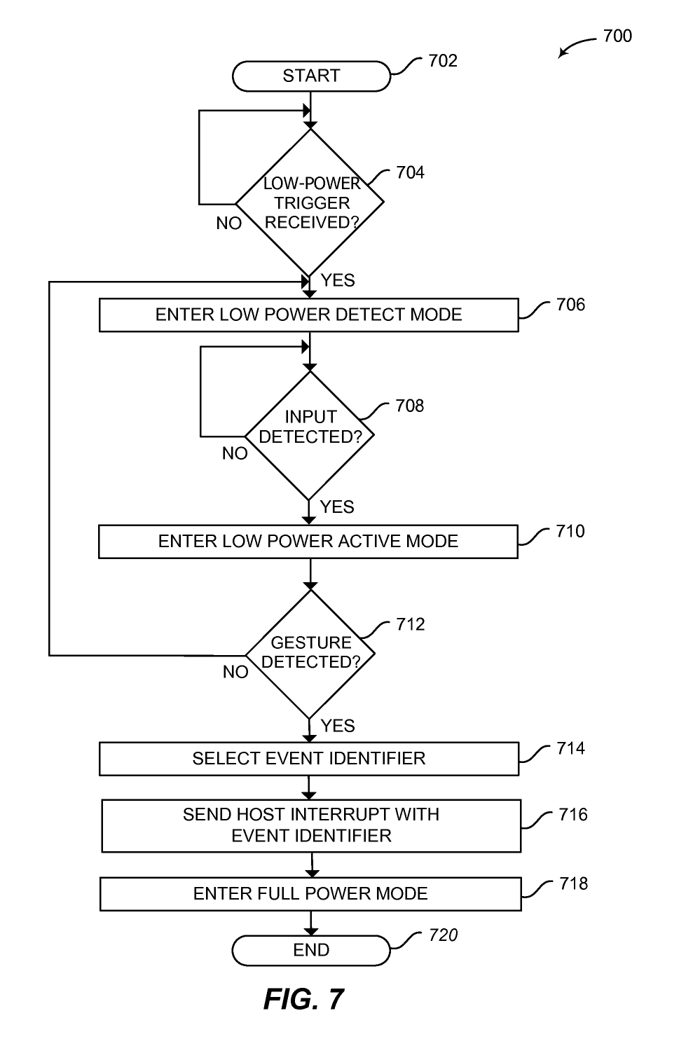

FIG. 7 illustrates a flowchart of a process 700 performed by the touch screen device 102 shown in FIG. 2, according to an embodiment of the present disclosure. The process 700 begins at 702. For example, the touch screen device 102 receives a low-power trigger signal from the host device 100 at 702. The process 700 then proceeds to 704.

At 704, the touch screen device 102 determines whether the low-power trigger signal has been received. For example, the microprocessor 126 or the power controller 124 determines whether the low-power trigger signal has been received by checking whether a signal line has a predetermined voltage level or whether a buffer (or other area of memory) has a predetermined value stored therein. In one embodiment, the microprocessor 126 receives the low-power trigger signal from the host interface 130, which receives the low-power trigger signal from the host device 100. In one embodiment, the power controller 124 receives the low-power trigger signal from the host interface 130, which receives the low-power trigger signal from the host device 100. If the low-power trigger signal is not received, the process 700 remains at 704 and the touch screen device 102 continues to check for the low-power trigger signal. If the low-power trigger signal is received at 704, the process 700 proceeds to 706.

At 706, the touch screen device 102 enters a low power detect mode (i.e., a first power consumption mode). In one embodiment, at 706, the power controller 124 causes a voltage level of a signal line connected to the microprocessor 126 to have a predetermined value, which causes the microprocessor 126 to enter a sleep state and periodically (e.g., 20 Hz) enter a wake state (i.e., exit the sleep state) and perform predetermined processing to determine whether a user input is detected, as explained below. In one embodiment, at 706, the microprocessor 126 sets a timer to a predetermined value, which causes the microprocessor 126 to enter the sleep state and periodically (e.g., 20 Hz) enter the wake state to perform the predetermined processing. The process 700 then proceeds to 708.

At 708, the touch screen device 102 determines whether a user input has been detected. For example, the touch screen device 102 operates in the self-sensing mode to determine whether an object (e.g., a stylus or a finger) has contacted or is in close proximity to the user input panel 121 of the touch screen panel 120. More particularly, the microprocessor 126 controls the processing circuitry 122 to provide the transmitting conductors T1 to T10 of the touch screen panel 120 with signals having one or more predetermined frequencies, amplitudes, and phases, and to provide the microprocessor 126 with values indicative of the capacitance between each of the receiving conductors R1 to R10 and the ground conductor G. The microprocessor 126 compares each of the values indicative of the capacitance between each of the receiving conductors R1 to R10 and the ground conductor G to a predetermined matching threshold. If one or more of those values is greater than the predetermined matching threshold, the microprocessor 126 determines that an object has contacted or is in close proximity to the user input surface 121 of the touch screen panel 120 and, thus, that user input has been detected. If not, the microprocessor 126 does not determine that user input has been detected. If the touch screen device 102 does not detect user input, the process 700 remains at 708 and the touch screen device 102 continues to determine whether a user input has been detected. If the touch screen device 102 detects the user input at 708, the process 700 proceeds to 710.

At 710, the touch screen device 102 enters a lower power active mode (i.e., a second power consumption mode). In one embodiment, at 710, the power controller 124 causes a voltage level of a signal line connected to the microprocessor 126 to have a predetermined value, which causes the microprocessor 126 to enter the sleep state and periodically (e.g., 90 Hz) enter the wake state and perform predetermined processing to determine whether a gesture is detected, as explained below. In one embodiment, at 710, the microprocessor 126 sets a timer to a predetermined value, which causes the microprocessor 126 to enter the sleep state and periodically (e.g., 90 Hz) enter the wake state and perform the predetermined processing. The process 700 then proceeds to 712.

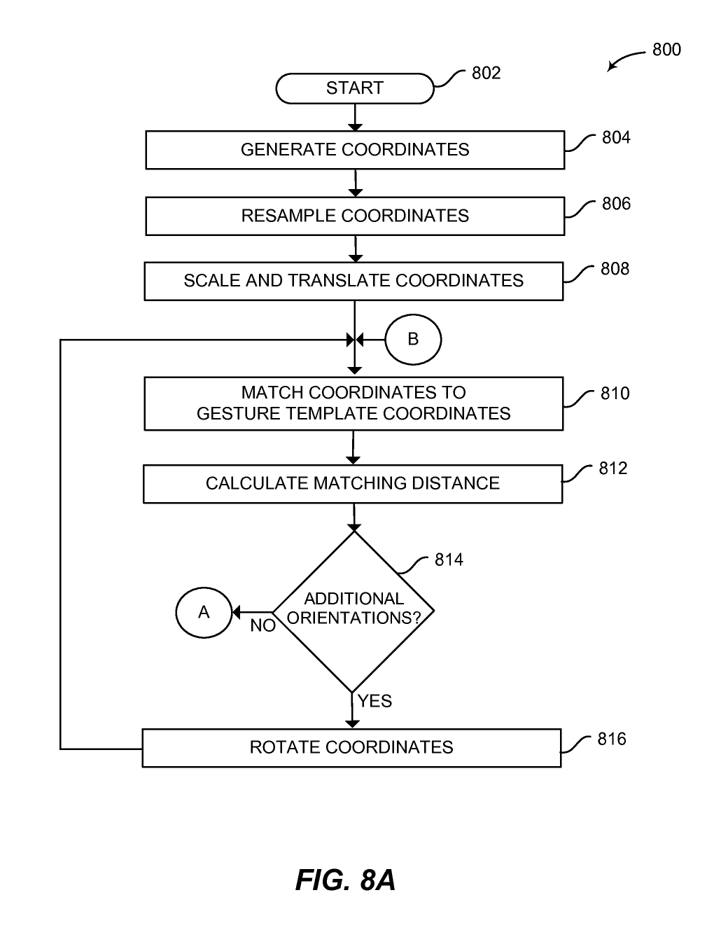

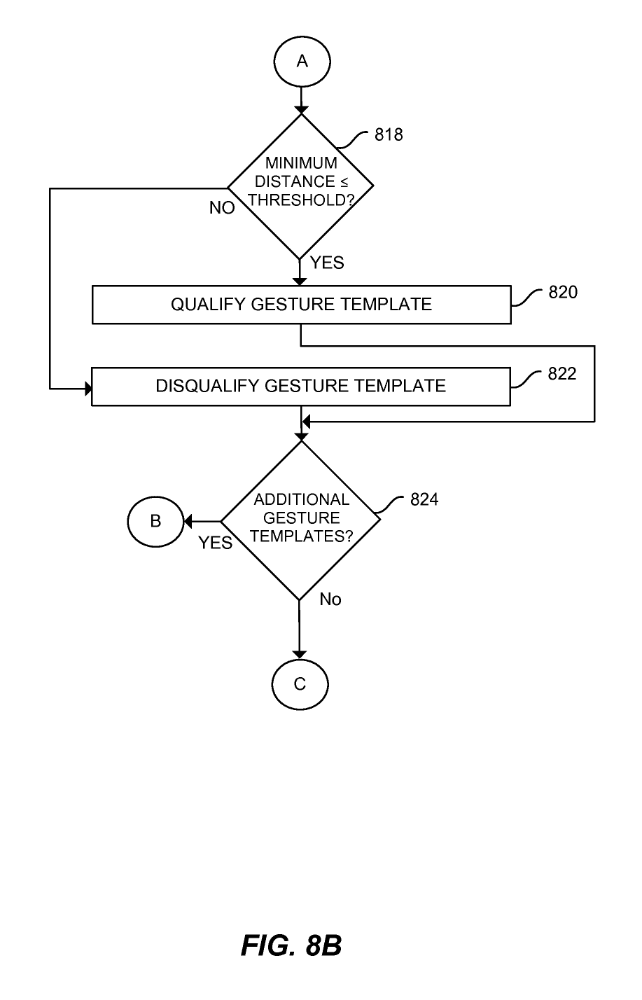

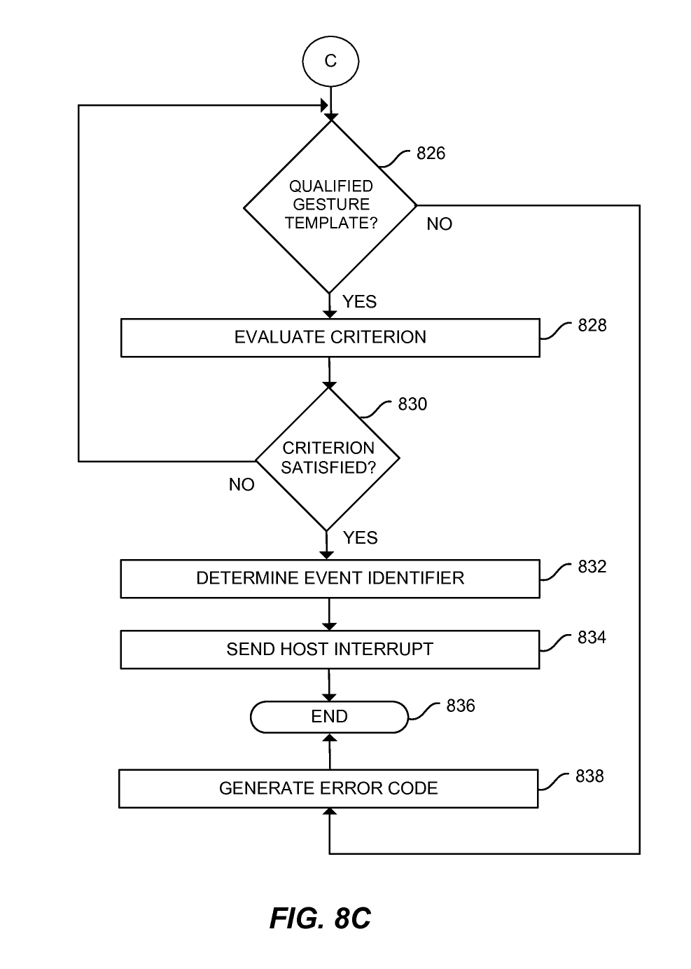

At 712, the touch screen device 102 determines whether a gesture is detected. For example, the microprocessor 126 executes instructions stored in the memory 128 causing the microcontroller 126 to perform predetermined processing, which is described more fully below with reference to FIGS. 8A-8C. If the touch screen device 102 does not detect a gesture at 712, the process returns to 706 and the touch screen device 102 enters the low power detect mode. If the touch screen device 102 detects a gesture at 712, the process 700 proceeds to 714.

At 714, the touch screen device 102 selects an event identifier. In one embodiment, the microprocessor 126 selects the event identifier 410 included in the gesture template 400 that was used to detect the gesture. In one embodiment, the microprocessor 126 selects the event identifier from a table (or other data structure) using the template identifier 402 included in the gesture template 400 that was used to detect the gesture as an index, wherein the table includes an entry that associates the template identifier 402 with the event identifier. The process 700 then proceeds to 716.

At 716, the touch screen device 102 sends a host interrupt along with the event identifier selected at 714 to the host device 100. For example, the microprocessor 126 provides a signal indicative of a host interrupt type and an event identifier to the host interface 130, which provides a signal indicative of the host interrupt 300 having the type field 302 set to the host interrupt type and the event identifier field 304 set to the event identifier to the host device 100. The process 700 then proceeds to 718.

At 718, the touch screen device 102 enters a full power mode (i.e., a third power consumption mode). In one embodiment, at 706, the power controller 124 causes a voltage level of a signal line connected to the microprocessor 126 to have a predetermined value, which causes the microprocessor 126 to enter a mode in which it does not enter the sleep state. In one embodiment, at 706, the microprocessor 126 sets an internal processing flag that causes it to operate without entering the sleep mode. In one embodiment, the touch screen device 102 enters the full power mode at 718 in response to receiving a command from the host device 100. The process 700 then ends at 720.

FIGS. 8A-8C illustrate a flowchart of a process 800 performed by the touch screen controller 102 to detect a gesture input via the touch screen panel 120, according to an embodiment of the present disclosure. The process 800 begins at 802. For example, the touch screen device 102 enters the low power active mode at 802. The process 800 then proceeds to 804.

At 804, the touch screen device 102 generates a plurality of coordinates corresponding to a temporal sequence of locations on the user input surface 121 of the touch screen panel 120 at which an object (e.g., a stylus or a finger) has come into contact with or close proximity to the user input surface 121 of the touch screen panel 120. The microprocessor 126 generates the coordinates at 804 based on signals received from the processing circuitry 122.

More particularly, the touch screen device 102 operates in the mutual-sensing mode and the microprocessor 126 receives signals from the processing circuitry 122, wherein each signal is indicative of a value of the capacitance at a location of the intersection of one of the transmitting conductors T1 to T10 and one of the receiving conductors R1 to R10. If the value of the capacitance at the location is less than a predetermined threshold value, the microprocessor 126 determines that the object has come into contact with or close proximity to the user input surface 121 of the touch screen device 120 at that location, and the microprocessor 126 generates a coordinate corresponding to the location. For example, if the value of the capacitance at the location corresponding to the intersection of the transmitting conductor T1 and the receiving conductor R1 is less than the predetermined matching threshold, the microprocessor 126 generates the coordinate (1,1). The touch screen device 102 continues scanning the transmitting conductors T1 to T10 and the receiving conductors R1 to R10 and generating coordinates until the object is no longer detected on in close proximity to the user input surface 121 of the touch screen panel 120.

The touch screen device 102 arranges the coordinates generated at 804 in an order indicating a temporal sequence of detected locations on the user input surface 121 of the touch screen panel 120. For example, the set of coordinates {(1,1), (2,2), (3,3)} indicates that an object first contacts the user input surface 121 of the touch screen panel 120 at a location corresponding to the intersection of the transmitting conductor T1 and the receiving conductor R1. The object is then moved to a location corresponding to the intersection of the transmitting conductor T2 and the receiving conductor R2. Subsequently, the object is moved to a location corresponding to the intersection of the transmitting conductor T3 and the receiving conductor R3, and is then moved away from the user input surface 121 of the touch screen panel 120.

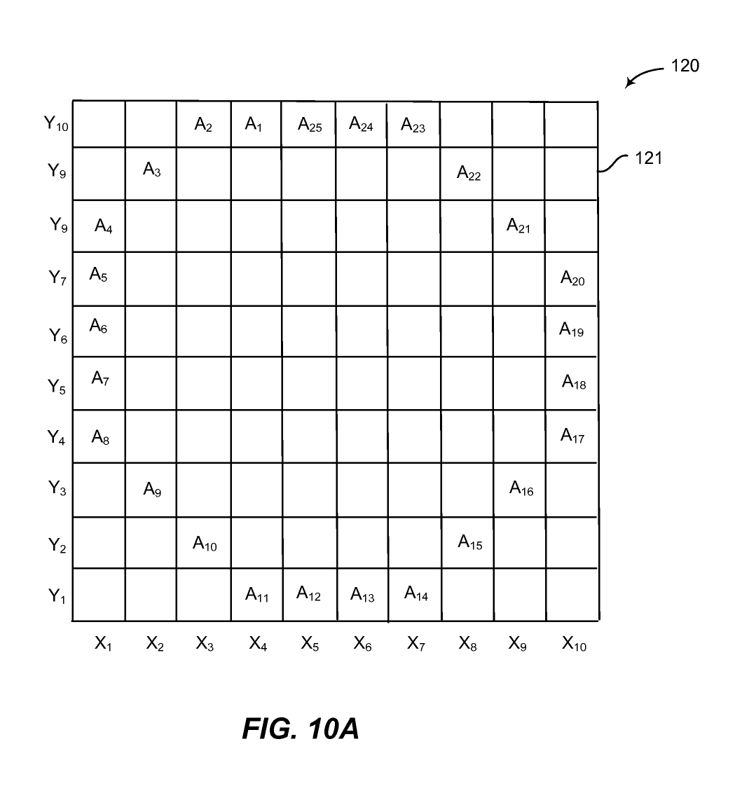

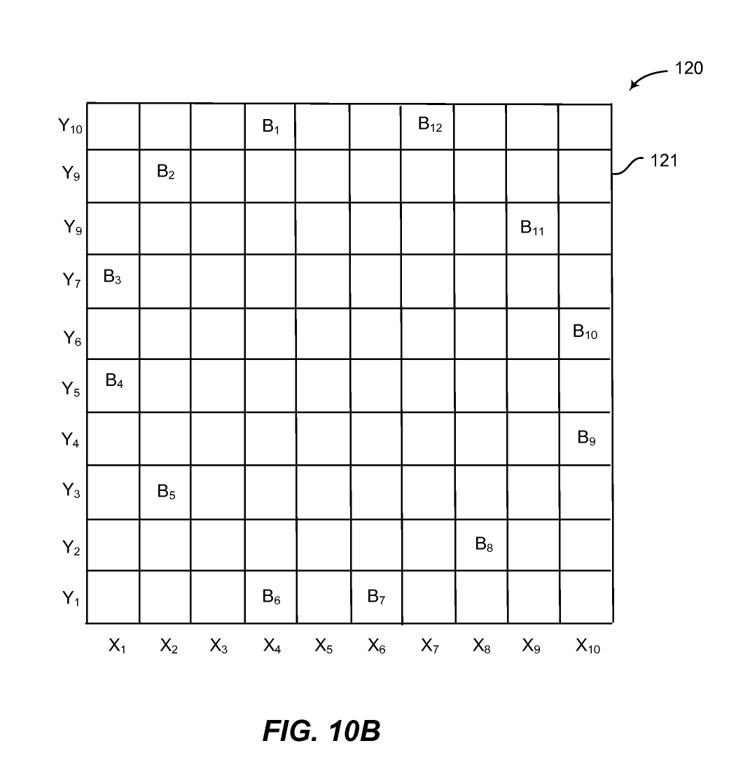

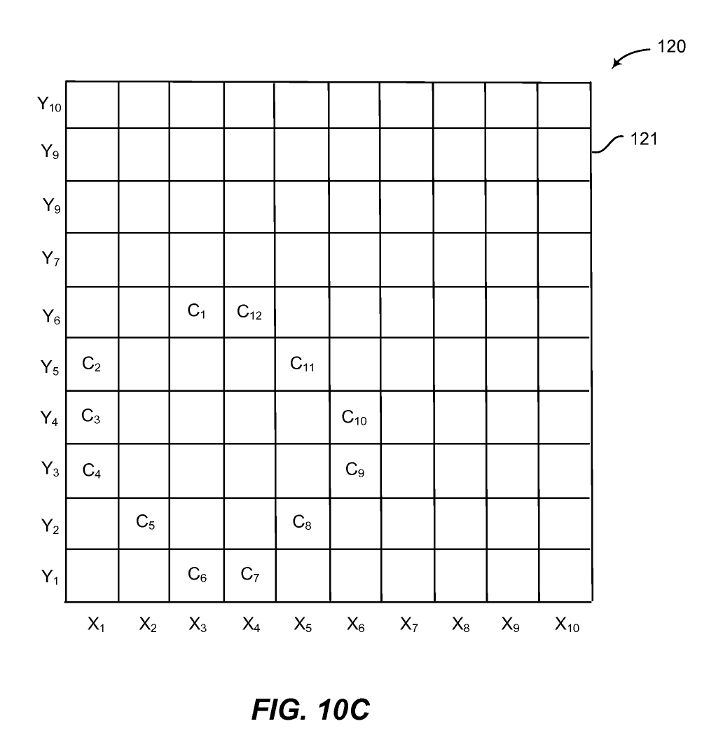

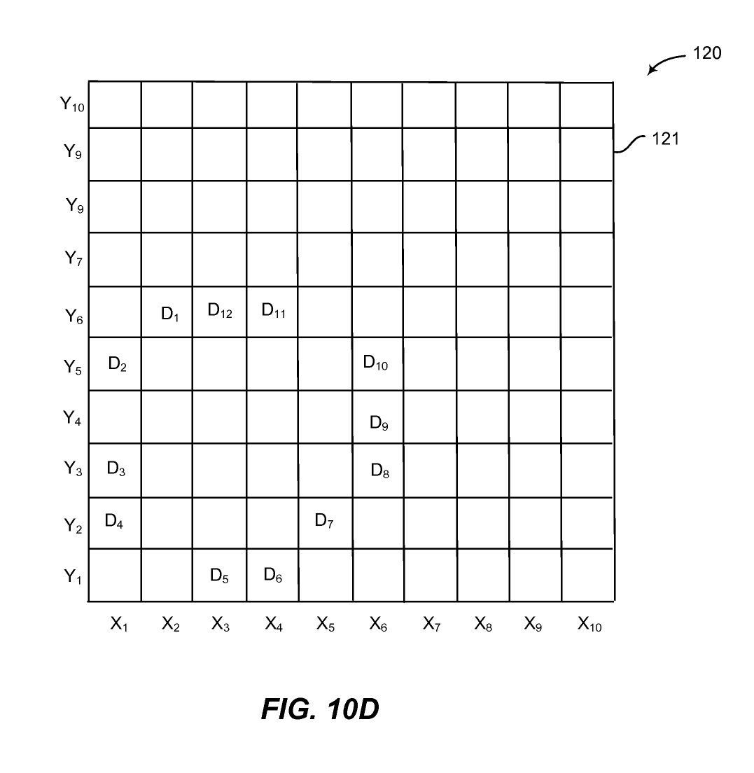

For example, FIG. 10A shows a plan view of the user input surface 121 of the touch screen panel 120 and twenty-five locations A₁ to A₂₅ at which an object has been detected. For example, a user first contacts the user input surface 121 of the touch screen panel 120 with her finger at location A₁ having coordinates (X₄, Y₁₀) and moves her finger in a counter-clockwise direction through the illustrated locations until her finger is at the location A₂₅ having coordinates (X₅, Y₁₀), and then moves her finger away from the touch screen panel 120. Thus, the microprocessor 126 generates coordinates corresponding to the locations A₁ to A₂₅ at 804. The process 800 then proceeds to 806.

At 806, the touch screen device 102 resamples the coordinates generated at 804 to obtain a predetermined number of coordinates, according to well-known techniques. For example, the microprocessor 126 calculates the average distance of the detected locations by dividing a total distance by the number of coordinates 404 included in each of the gesture templates 400. The microprocessor 126 keeps a coordinate if the corresponding location is at a multiple of the average distance; if there is no such coordinate, the next coordinate is kept. The resampling performed at 806 makes sure the input gesture is represented by the same number of coordinates included in the gesture templates 400, regardless of the speed at which the gesture is drawn. For example, at 806, the microprocessor 126 processes coordinates corresponding to the locations A₁ to A₂₅ shown in FIG. 10A, and then generates coordinates corresponding to the locations B₁ to B₁₂ shown in FIG. 10B. The process 800 then proceeds to 808.

At 808, the touch screen device 102 scales and translates the coordinates generated at 806 according to well-known techniques. For example, the microprocessor 126 scales the resampled input to fit within a square having a predetermined size. The microprocessor 126 calculates the centroid of the scaled input gesture and uses it as the origin, and then translates the gesture to the origin. The scaling and translation make locations corresponding to the input gesture have the same size and position as the locations corresponding to the coordinates included in the gesture templates 400. For example, at 808, the microprocessor 126 processes coordinates corresponding to the locations B₁ to B₁₂ shown in FIG. 10B, and then generates coordinates corresponding to the locations C₁ to C₁₂ shown in FIG. 10C. That is, the microprocessor 126 may generate the following coordinates: (X₃, Y₆), (X₁, Y₅), (X₁, Y₄), (X₁, Y₃), (X₂, Y₂), (X₃, Y₁), (X₄, Y₁), (X₅, Y₂), (X₆, Y₃), (X₆, Y₄), (X₅, Y₅), and (X₄, Y₆). The process 800 then proceeds to 810.

At 810, the touch screen device 102 matches the coordinates generated at 808 to the coordinates 404 included in one of the gesture templates 400 stored in the memory 128. FIG. 9A shows a plan view of the user input surface 121 of the touch screen panel 120 with locations L₁ to L₁₂ corresponding to the coordinates 404 included in the gesture template 400. That is, the coordinates 404 of the gesture template 400 corresponding to the locations L₁ to L₁₂ are (X₄, Y₆), (X₃, Y₆), (X₂, Y₅), (X₁, Y₄), (X₁, Y₃), (X₂, Y₂), (X₃, Y₁), (X₄, Y₁), (X₅, Y₂), (X₆, Y₃), (X₆, Y₄), and (X₅, Y₅). The microprocessor 126 matches the coordinates generated at 808 to the coordinates 404 such that a first coordinate generated at 808 is matched to the a first coordinate included in the coordinates 404, the second coordinate generated at 808 is matched to a second coordinate included in the coordinates 404, etc. The process 800 then proceeds to 812.

At 812, the touch screen device 102 calculates a matching distance using the coordinates generated at 808 and the coordinates 404 included in the gesture template 400. The microprocessor 126 generates an individual matching distance for each of the coordinates matched at 810. The microprocessor 126 then obtains a composite matching distance by summing the individual matching distances. The microprocessor 126 generates each individual matching distance based on the fact that a distance d between coordinates (x1, y1) and (x2, y2) is given by the equation d=\sqrt{(x1−x2)²+(y1−y2)²}. According to one technique, the microprocessor 126 obtains each individual matching distance by calculating a value for ΔX and a value for ΔY, for each of the coordinates 404 included in a gesture template, squaring and summing the values for ΔX and ΔY, and then taking the square root of the result; the microprocessor 126 then obtains a composite matching distance by summing the individual matching distances. According to another technique that can reduce processing time, the microprocessor 126 obtains each individual matching distance by calculating a value for ΔX and a value for ΔY, for each of the coordinates 404 included in a gesture template, and then squaring and summing the values for ΔX and ΔY; the microprocessor 126 then obtains a composite matching distance by summing the individual matching distances.

TABLE 1

| Coordinates | | | | Matching |
|---|---|---|---|---|
| Corresponding | Template | X Difference | Y Difference | Distance |
| to User Input | Coordinates | (ΔX) | (ΔY) | (ΔX² + ΔY²) |
| (X₃, Y₆) | (X₄, Y₆) | 1 | 0 | 1 |
| (X₁, Y₅) | (X₃, Y₆) | 2 | 1 | 5 |
| (X₁, Y₄) | (X₂, Y₅) | 1 | 1 | 2 |
| (X₁, Y₃) | (X₁, Y₄) | 0 | 1 | 1 |
| (X₂, Y₂) | (X₁, Y₃) | 1 | 1 | 2 |
| (X₃, Y₁) | (X₂, Y₂) | 1 | 1 | 2 |
| (X₄, Y₁) | (X₃, Y₁) | 1 | 0 | 1 |
| (X₅, Y₂) | (X₄, Y₁) | 1 | 1 | 2 |
| (X₆, Y₃) | (X₅, Y₂) | 1 | 1 | 2 |
| (X₆, Y₄) | (X₆, Y₃) | 0 | 1 | 1 |
| (X₅, Y₅) | (X₆, Y₄) | 1 | 1 | 2 |
| (X₄, Y₆) | (X₅, Y₅) | 1 | 1 | 2 |
| | | | Sum | 23 |

For example, the microprocessor 126 calculates the individual matching distances shown in Table 1, and sums them to obtain a composite matching distance of 23, which is then stored, for example, in the memory 128. The process 800 then proceeds to 814.

At 814, the touch screen device 102 determines whether additional orientations are to be used. For example, the memory 128 stores values for predetermined orientations to be used, including −30°, −25°, −20°, −15°, −10°, −5°, 5°, 10°, 15°, 20°, 25°, 30°, wherein 0° corresponds to the orientation of the coordinates generated at 808. The microprocessor 126 keeps track of orientations that have been used already in connection with the coordinates generated at 808. If the microprocessor 126 determines that no other orientation is to be used, the process 800 proceeds to 818. If the touch screen device 102 determines that another orientation is to be used, the process 800 proceeds to 816.

At 816, the touch screen device 102 rotates the coordinates generated at 808 by one of the orientations that have not been used, according to well-known techniques. For example, FIG. 10D shows locations D₁ to D₁₂ corresponding to the coordinates generated at 816, which result from rotating the coordinates corresponding to the locations C₁ to C₁₂ shown in FIG. 10C by −5°. That is, the location D₁ shown in FIG. 10D corresponds to the location C₁ shown in FIG. 100 rotated by −5°, the location D₂ shown in FIG. 10D corresponds to the location C₂ shown in FIG. 100 rotated by −5°, etc. The process 800 then returns to 810. At 810, the coordinates generated at 816 are matched to the coordinates generated at 808, and at 812 a composite matching distance is calculated based on those coordinates. This repeats until the coordinates generated at 808 have been rotated according to each of the predetermined orientations.

At 818, the touch screen device 102 determines a minimum composite matching distance obtained using the coordinates 404 included in the gesture template 400 and the coordinates generated at 808 or 816, and compares the minimum composite matching distance to the matching threshold 406 included in the gesture template 400. For example, if the microprocessor 126 obtains composite matching distance values of {29, 32, 21, 22, 25, 29, 28, 29, 32, 27, 22, 28, 25} for the orientations {−30°, −25°, −20°, −15°, −10°, −5°, 0°, 5°, 10°, 15°, 20°, 25°, 30° }, respectively, the microprocessor 126 determines that the minimum composite matching distance for the gesture template 400 is 21. The microprocessor 126 then compares the minimum matching distance to the matching threshold 406 included in the gesture template 400. If the microprocessor 126 determines the minimum composite matching distance is less than or equal to the matching threshold 406 included in the gesture template 400, the process 800 proceeds to 820. If not, the process 800 proceeds to 822.

At 820, the touch screen device 102 qualifies the gesture template 400. For example, the microprocessor 126 stores the template identifier 402 included in the gesture template 400, the minimum matching distance, and a value corresponding to the orientation (e.g., −20°) that resulted in the minimum matching distance in a table of qualified gesture templates (or other data structure) in the memory 128. The process 800 then proceeds to 824.

At 822, the touch screen device 102 disqualifies the gesture template 400. For example, the microprocessor 126 stores the template identifier 402 included in the gesture template 400 in a table of disqualified gesture templates (or other data structure) in the memory 128. The process 800 then proceeds to 824.

At 824, the touch screen device 102 determines whether there is another gesture template 400 to be used. For example, the memory 128 stores a master table of gesture templates (or other data structure) that includes the template identifier 402 included in each of the gesture templates 400 stored in the memory 128. The microprocessor 126 compares the template identifiers 402 included in the master table of gesture templates to those included in the table of qualified gesture templates and the table of disqualified gesture templates. If the microprocessor 126 determines there is another gesture template 400 that has not been qualified or disqualified, the process returns to 810 and the coordinates 404 included in the other gesture template 400 are matched to the coordinates obtained at 808. The acts 812, 814, 816, and 818 described above are then repeated for the other gesture template 400 stored in the memory 128, which are then qualified or disqualified in 820 or 822, respectively. If there is not another gesture template 400 to be used, the process 800 proceeds to 826. That is, if the microprocessor 126 has determined a minimum composite matching distance for each of the gesture templates 400 stored in the memory 128, the process 800 proceeds to 826.

At 826, the touch screen device 102 determines whether there is at least one qualified gesture template 400. For example, the microprocessor 126 determines whether at least one template identifier 402 is included in the table of qualified gesture templates that is stored in the memory 128. If the touch screen device 102 determines that is at least one qualified gesture template 400, the process 800 proceeds to 828. If not, the process 800 proceeds to 838.

At the 838, the touch screen device 102 generates an error code. For example, the microprocessor 126 sends a predetermined signal to the power controller 124. In response, the power controller 124 causes the touch screen device 102 to enter the low power detect mode, as explained above. The process 800 then ends at 836.

If there is at least one qualified gesture template 400, at 828, the touch screen device 102 determines whether the criterion 408 included in the qualified gesture template 400 having a lowest composite matching distance is satisfied. That is, the touch screen device 102 evaluates the criterion 408 included in a first qualified gesture template 400 having coordinates 404 that most closely match the coordinates obtained at 808 or 816. For example, the microprocessor 126 reads the criterion 408 from the first qualified gesture template 400 and performs processing indicated by the criterion 408.

In one embodiment, the criterion 408 includes information indicating two coordinates, a property, a relationship, and a value. More particularly, the criterion 408 identifies the first (i.e., initial) coordinate and the last coordinate of the coordinates generated at 808 or 816, whichever resulted in the lowest composite matching distance. For example, the coordinates are stored in an array of coordinates having an array size of N. The first coordinate is indicated by 0, which corresponds to the first element of the array, and the last coordinate is indicated by the value N−1, which corresponds to the last element of the array. The criterion 408 also identifies a property such as “distance”, a relationship such as “less than or equal to”, and a value such as “5”. The microprocessor 126 evaluates the criterion 408 by calculating a value for the distance between the first coordinate and the last coordinate. The microprocessor 126 compares the calculated value for the distance between the first coordinate and the last coordinate to the value included in the criterion 408. If the microprocessor 126 determines the calculated value for the distance between the first coordinate and the last coordinate is less than or equal to 5, the microprocessor 126 determines that the criterion 408 is satisfied. If not, the microprocessor 126 does not determine that the criterion 408 is satisfied. If the touch screen device 102 determines at 830 that the criterion 408 is satisfied, the process 800 proceeds to 832. If not, the process 800 returns to 826 and, if there is another qualified gesture template 400, the criterion 408 included in the gesture template 400 determined to have the next lowest composite matching distance is evaluated at 828.

In one embodiment, one of the gesture templates 400 is used to determine whether an input gesture corresponds to the letter “O”. The criterion 408 included in the gesture template 400 is based on the shape of the letter “O”. For example, if a person is asked to draw the letter “O” with her finger on the lower, left portion of the user input surface 121 of the touch screen panel 120 shown in FIG. 9A, the person is likely to place her finger on the user input surface 121 of the touch screen panel 120 at a first location (e.g., L₁), start drawing the letter “O”, finish drawing the letter “O” near a last location (e.g., L₁₂), and then lift her finger off of the user input surface 121 of the touch screen panel 120. It is likely that the first location is relatively close to the last location. For example, as shown in FIG. 9A, the location L₁ is very close to the location L₁₂. The touch screen device 102 can distinguish a gesture corresponding to the letter “O” from a similar gesture (e.g., a gesture corresponding to the letter “C”) by determining if the first location is sufficiently close to the last location. Stated differently, the touch screen device 102 can distinguish a gesture corresponding to the letter “O” from a similar gesture by determining that a distance between the first location and the last location is less than (or equal to) a threshold distance having a relatively small value.

In one embodiment, one of the gesture templates 400 is used to determine whether an input gesture corresponds to the letter “C”. The criterion 408 included in the gesture template 400 is based on the shape of the letter “C”. For example, if a person is asked to draw the letter “C” with her finger on the lower, left portion of the user input surface 121 of the touch screen panel 120 shown in FIG. 9B, the person is likely to place her finger on the touch screen panel 120 at a first location (e.g., L₁), start drawing the letter “C”, finish drawing the letter “C” near a last location (e.g., L₁₂), and then lift her finger off of the user input surface 121 of the touch screen panel 120. It is likely that the first location is spaced apart from the last location by a relatively small distance. For example, as shown in FIG. 9B, the location L₁ is spaced apart from the location L₁₂ by a small distance. The touch screen device 102 can distinguish a gesture corresponding to the letter “C” from a similar gesture (e.g., a gesture corresponding to the letter “O”) by determining that the first location is spaced apart from the last location by a predetermined distance. Stated differently, the touch screen device 102 can distinguish a gesture corresponding to the letter “C” from a similar gesture by determining if a distance between the first location and the last location is greater than (or equal to) a predetermined threshold distance having a relatively small value. The criterion 408 can specify multiple relationships. For example, the touch screen device 102 can distinguish a gesture corresponding to the letter “C” from a similar gesture by determining that a distance between the first location and the last location is greater than or equal to a first value and less than or equal to a second value.

In one embodiment, one of the gesture templates 400 is used to determine whether an input gesture corresponds to the letter “M”. The criterion 408 included in the third gesture template 400 is based on the shape of the letter “M”. For example, if a person is asked to draw the letter “M” with her finger on the lower, left portion of the user input surface 121 of the touch screen panel 120 shown in FIG. 9C, the person is likely to place her finger on the touch screen panel 120 at a first location (e.g., L₁), draw the left vertical portion of the letter “M”, draw the middle portion of the letter “M” centered around a middle location (e.g., L₆), draw the right vertical portion of the letter “M” finishing near a last location (e.g., L₁₂), and then lift her finger off of the touch screen panel 120. It is likely that the first location (e.g., L₁) is within a first range of coordinates including (X₁, Y₁), (X₂, Y₁), (X₁, Y₂), and (X₂, Y₂); a middle location (e.g., L₆) is within a second range of coordinates including (X₃, Y₃), (X₃, Y₄), (X₄, Y₃), and (X₄, Y₄); and the last location (e.g., L₁₂) is within a third range of coordinates including (X₅, Y₁), (X₅, Y₁), (X₅, Y₂), and (X₅, Y₂). The touch screen device 102 can confirm whether the letter “M” has been drawn by determining whether coordinates corresponding to the first location, a middle location, and the last location are within the respective ranges mentioned above. In one embodiment, a range of coordinates is specified by four coordinates corresponding to the vertices of a rectangular region that includes the coordinates. For example, a range of coordinates that includes the coordinates (X₃, Y₃), (X₃, Y₄), (X₄, Y₃), (X₄, Y₄), (X₃, Y₅), and (X₄, Y₅) may be specified using the coordinates (X₃, Y₃), (X₃, Y₅), (X₄, Y₃), and (X₄, Y₅).

If the touch screen device 102 determines that the criterion 408 of the gesture template 400 is satisfied at 830, the process 800 proceeds to 832. If not, the process 800 returns to 826.

At 832, the touch screen device 102 determines an event identifier corresponding to the gesture template 400 having the criterion 408 that was determined to be satisfied at 830. For example, the microprocessor 126 reads the event identifier 410 from the gesture template 400 having the criterion 408 that was determined to be satisfied at 830. Alternatively, the microprocessor 126 searches a table (or other data structure) that associates event identifiers with corresponding template identifiers for the template identifier 402 of the gesture template 400 having the criterion 408 that was determined to be satisfied at 830, and reads the corresponding the event identifier from the table. The process 800 then proceeds to 834.

At 834, the touch screen device 102 sends a host interrupt with the event identifier determined at 832 to the host device 100. For example, the microprocessor 126 provides the host interface 130 with values corresponding to a host interrupt type and the event identifier value determined at 832, and instructs the host interface 130 to send a host interrupt 300 having the type field 302 and the event identifier field 304 set to those values, respectively, to the host device 100. The process then ends at 836.

As described above, the touch screen device 102 can confirm whether predetermined gestures have been input via the user input surface 121 of the touch screen panel 120 using coordinates associated with an input gesture and the gesture templates 400. The touch screen device 102 uses the coordinates associated with the input gesture and the coordinates 404 included in each of the gesture templates 400 to obtain a composite minimum matching distance for each of the gesture templates 400. The touch screen device 102 compares the composite minimum matching distance for each gesture template 400 to the matching threshold 406 included in the gesture template 400, and qualifies the gesture template 400 as a possible matching gesture template if the composite minimum matching distance obtained for the gesture template 400 is less than or equal to the matching threshold 406 included in the template. The touch screen device 102 then evaluates the criterion 408 included in at least one qualified gesture template 400, if any. Starting with the qualified gesture template 400 for which a lowest composite minimum matching distance was obtained, the touch screen device 102 evaluates the criterion 408 included the gesture template 400. If the criterion 408 included the gesture template 400 is not satisfied, the touch screen device 102 evaluates the criterion 408 included the gesture template 400 for which the next lowest composite minimum matching distance was obtained. If the criterion 408 included the gesture template 400 is satisfied, the touch screen device 102 obtains an event identifier corresponding to (i.e., associated with) the gesture template 400 having the criterion 408 that was determined to be satisfied. The touch screen device 102 then sends to the host device 100 a host interrupt 300 with the event identifier field 304 set to the obtained event identifier. In response, the host device 100 exits a low power consumption mode and opens (or restores) an application associated with the event identifier included in the event identifier field 304 of the host interrupt 300. Accordingly, a user is able to specify a particular application to be opened by the host device 100 upon exiting the low power consumption mode by entering via the touch screen panel 120 a particular gesture that is associated with the application.

In one embodiment, the accelerometer 110 outputs a signal that inhibits the microprocessor 126 from detecting a gesture, when it senses an acceleration that is greater than a predetermined acceleration. For example, the signal may be provided to a signal line connected to the microprocessor 126; when the microprocessor 126 determines that the signal line has a predetermined voltage level, the microprocessor 126 does not exit the low power detect mode. Accordingly, if input is detected while a user moves the host device 100 at an acceleration that is greater than the predetermined acceleration, the microprocessor 126 does not enter the lower power active mode and attempt to determine a gesture corresponding to the input.

In one embodiment, the proximity sensor 112 outputs a signal that inhibits the microprocessor 126 from detecting a gesture, when it senses an object within a predetermined distance. For example, the signal may be provided to a signal line connected to the microprocessor 126; when the microprocessor 126 determines that the signal line has a predetermined voltage level, the microprocessor 126 does not exit the low power detect mode. Accordingly, if input is detected while the host device 100 is in a user's pocket, for example, the microprocessor 126 does not enter the lower power active mode and attempt to determine a gesture corresponding to the input.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

The gesture templates 400 may include other coordinates 404, matching thresholds 406, and criteria 408 useful for detecting different letters, symbols, and other gestures, without departing from the scope of the present disclosure. A criterion 408 may include multiple criteria for determining whether coordinates associated with an input gesture correspond to a particular gesture template 400. For example, a criterion 408 may require the distance between the first coordinate and the last coordinate to be less than or equal to a specified distance, and also require another coordinate such as a middle coordinate to be within a specified range of coordinates.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
processing circuitry configured to communicate with a touch screen panel;
a processor coupled to the processing circuitry; and
a memory coupled to the processor, the memory storing a plurality of gesture templates, each of the gesture templates including a template identifier, a matching threshold, a criterion, and a first plurality of coordinates, each of the first plurality of coordinates corresponding to a location on the touch screen panel, the memory further storing processor-executable instructions that, when executed by the processor, cause the device to:
obtain a second plurality of coordinates, each of the second plurality of coordinates corresponding to a location on the touch screen panel;
obtain a matching distance using the first plurality of coordinates included in a first gesture template of the plurality of gesture templates and the second plurality of coordinates;
compare the matching distance to the matching threshold included in the first gesture template;
determine that at least one of the second plurality of coordinates satisfies the criterion included in the first gesture template; and
send a host interrupt with an event identifier associated with the first gesture template.

2. The device according to claim 1 wherein
the second plurality of coordinates is arranged in an order indicating a temporal sequence of detected locations on the touch screen panel, and
the criterion included in the first gesture template indicates that a distance between an initial coordinate and a last coordinate of the second plurality of coordinates is less than a specified distance.

3. The device according to claim 1 wherein
the second plurality of coordinates is arranged in an order indicating a temporal sequence of detected locations on the touch screen panel, and
the criterion included in the first gesture template indicates that a distance between an initial coordinate and a last coordinate of the second plurality of coordinates is greater than a specified distance.

4. The device according to claim 1 wherein
the second plurality of coordinates is arranged in an order indicating a temporal sequence of detected locations on the touch screen panel, and
the criterion included in the first gesture template indicates that a first coordinate of the second plurality of coordinates is within a first specified range of coordinates.

5. The device according to claim 4 wherein the criterion included in the first gesture template indicates that a second coordinate of the second plurality of coordinates is within a second specified range of coordinates.

6. The device according to claim 1 wherein the processor-executable instructions, when executed by the processor, cause the device to:
determine that a matching distance obtained using the first plurality of coordinates included in a second gesture template and the second plurality of coordinates is less than or equal to the matching threshold included in the second gesture template; and
determine that at least one of the second plurality of coordinates does not satisfy the criterion included in the second gesture template.

7. The device according to claim 6 wherein the matching distance obtained using the first plurality of coordinates included in the second gesture template is less than the matching distance obtained using the first plurality of coordinates included in the first gesture template.

8. The device according to claim 1 wherein the processor is configured to receive a signal from an accelerometer, the signal inhibiting the processor from detecting the gesture.

9. The device according to claim 1 wherein the processor is configured to receive a signal from a proximity sensor, the signal inhibiting the processor from detecting the gesture.

10. The device according to claim 1, comprising:
the touch screen panel.

11. The device according to claim 10 wherein the processor-executable instructions, when executed by the processor, cause the device to compare a value indicative of a capacitance between at least two conductors included in the touch screen panel to a threshold value.

12. The device according to claim 10, comprising:
a display device.

13. A device, comprising:
a display device;
a touch screen panel;
processing circuitry coupled to the touch screen panel;
a first processor coupled to the processing circuitry;
a second processor coupled to the first processor;
a first memory coupled to the first processor, the first memory storing a plurality of gesture templates, each of the gesture templates including a template identifier, a matching threshold, a criterion, and a first plurality of coordinates, each of the first plurality of coordinates corresponding to a location on the touch screen panel, the memory further storing processor-executable instructions that, when executed by the processor, cause the first processor to:
obtain a second plurality of coordinates, each of the second plurality of coordinates corresponding to a location on the touch screen panel;
obtain a matching distance using the first plurality of coordinates included in a first gesture template of the plurality of gesture templates and the second plurality of coordinates;
compare the matching distance to the matching threshold included in the first gesture template;
determine that at least one of the second plurality of coordinates satisfies the criterion included in the first gesture template; and
cause a host interrupt with an event identifier associated with the first gesture template to be sent to the second processor; and
a second memory coupled to the second processor, the second memory storing processor-executable instructions that, when executed by the second processor, cause the second processor to:
open an application corresponding to the event identifier, in response to receiving the host interrupt with the event identifier.

14. The device according to claim 13 wherein the second memory stores processor-executable instructions that, when executed by the second processor, cause a wake-up signal to be sent to the first processor, in response to receiving the host interrupt with the event identifier.

15. The device according to claim 13 wherein the second memory stores processor-executable instructions that, when executed by the second processor, cause the second processor to send a wake-up signal to the display device, in response to receiving the host interrupt with the event identifier.

16. A method, comprising
storing a plurality of gesture templates in a processor-readable memory device, each of the gesture templates including a template identifier, a matching threshold, a criterion, and a first plurality of coordinates, each of the first plurality of coordinates corresponding to a location on a touch screen panel;
obtaining a second plurality of coordinates, each of the second plurality of coordinates corresponding to a location on the touch screen panel;
selecting a first gesture template of the plurality of gesture templates based on the matching threshold, criterion, and first plurality of coordinates included in the first gesture template and the second plurality of coordinates;
obtaining an event identifier associated with the first gesture template; and
sending a host interrupt with the event identifier.

17. The method of claim 16 wherein selecting the first gesture template includes:
obtaining a matching distance using the first plurality of coordinates included in the first gesture template and the second plurality of coordinates;
comparing the matching distance to the matching threshold included in the first gesture template; and
determining that at least one of the second plurality of coordinates satisfies the criterion included in the first gesture template.

18. The method of claim 17 wherein
the second plurality of coordinates is arranged in an order indicating a temporal sequence of detected locations on the touch screen panel, and
determining that at least one of the second plurality of coordinates satisfies the criterion included in the first gesture template includes determining that a distance between an initial coordinate and a last coordinate of the second plurality of coordinates is less than a distance specified by the criterion included in the first gesture template.

19. The method of claim 17 wherein
the second plurality of coordinates is arranged in an order indicating a temporal sequence of detected locations on the touch screen panel, and
determining that at least one of the second plurality of coordinates satisfies the criterion included in the first gesture template includes determining that a distance between an initial coordinate and a last coordinate of the second plurality of coordinates is greater than a distance specified by the criterion included in the first gesture template.

20. The method of claim 17 wherein
the second plurality of coordinates is arranged in an order indicating a temporal sequence of detected locations on the touch screen panel, and
determining that at least one of the second plurality of coordinates satisfies the criterion included in the first gesture template includes determining that at least one coordinate of the second plurality of coordinates is within a range of coordinates specified by the criterion included in the first gesture template.
